(19) United States
(12) Patent Application Publication
(10) Pub. No.: US 2025/0272972 A1
(43) Pub. Date: Aug. 28, 2025

(54) VIDEO CAPTURE DEVICE CONTROL BASED ON METADATA RELATED TO A VIDEO ENVIRONMENT

(71) Applicant: Shure Acquisition Holdings, Inc., Niles, IL (US)

(72) Inventors: Yichong Yan, Prosper, TX (US); Nathan Seitz, Austin, TX (US); Daniel Law, Glencoe, IL (US)

(21) Appl. No.: 19/060,180

(22) Filed: Feb. 21, 2025

Related U.S. Application Data
(60) Provisional application No. 63/556,431, filed on Feb. 22, 2024.

(51) Int. Cl. G06V 10/98; G06V 10/10; G06V 10/77; G06V 20/40; G06V 40/10; G06V 40/18

(52) U.S. Cl. CPC G06V 10/993; G06V 10/10; G06V 10/77; G06V 20/46; G06V 40/10; G06V 40/18; G06V 2201/10

(57) ABSTRACT

Techniques are disclosed herein for providing video capture device control based on metadata related to a video environment. Examples may include receiving metadata generated by at least one machine learning model associated with at least one video capture device located within a video environment, generating a view quality score for the video environment based at least in part on the metadata, generating control data for the at least one video capture device based at least in part on the view quality score, and outputting the control data to the at least one video capture device.

### CROSS REFERENCE TO RELATED APPLICATIONS

This application claims the benefit of U.S. Provisional Patent Application No. 63/556,431, titled “VIDEO CAPTURE DEVICE CONTROL BASED ON METADATA RELATED TO A VIDEO ENVIRONMENT,” and filed on Feb. 22, 2024, the entirety of which is hereby incorporated by reference.

### TECHNICAL FIELD

Embodiments of the present disclosure relate generally to video processing and, more particularly, to systems configured to control video capture devices.

### BACKGROUND

Applicant has identified many deficiencies and problems associated with existing techniques for capturing, processing, and/or transmitting video data captured by video captured devices in a video environment. Through applied effort, ingenuity, and innovation, many of these identified deficiencies and problems have been solved by developing solutions that are configured in accordance with embodiments of the present disclosure, many examples of which are described herein.

### BRIEF SUMMARY

Various embodiments of the present disclosure are directed to apparatuses, systems, methods, and computer readable media for providing video capture device control based on metadata related to a video environment. These characteristics as well as additional features, functions, and details of various embodiments are described below. The claims set forth herein further serve as a summary of this disclosure.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an example video processing system configured to execute audio/video (AV) processing operations related to video events in accordance with one or more embodiments disclosed herein;

FIG. 2 illustrates an example AV processing apparatus configured in accordance with one or more embodiments disclosed herein;

FIG. 3 illustrates an example network system in accordance with one or more embodiments disclosed herein;

FIG. 4 illustrates an example transmitter system in accordance with one or more embodiments disclosed herein;

FIG. 5 illustrates an example receiver system in accordance with one or more embodiments disclosed herein;

FIG. 6 illustrates an example score computation architecture in accordance with one or more embodiments disclosed herein;

FIG. 7 illustrates an example device control architecture in accordance with one or more embodiments disclosed herein;

FIG. 8 illustrates an example machine learning architecture in accordance with one or more embodiments disclosed herein;

FIG. 9 illustrates an example video environment in accordance with one or more embodiments disclosed herein;

FIG. 10 illustrates an example method for providing video capture device control based on metadata related to a video environment in accordance with one or more embodiments disclosed herein; and

FIG. 11 illustrates another example method for providing video capture device control based on metadata related to a video environment in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

An audio video (AV) conferencing system may include multiple video cameras to capture video data in a video environment. The captured video data may be transmitted between devices in the video environment and/or another environment via a network. For example, a remote hub may receive and process the captured video data from the video cameras. The remote hub may also transmit the processed video data to one or more display devices in the video environment and/or another environment via a network. In certain scenarios, a video environment may be a conference room environment with multiple video cameras. However, in such a scenario, one or more of the video cameras may transmit unnecessary and/or irrelevant video streams for the video environment, resulting in inefficient bandwidth usage of video transmission for the video environment. As such, in certain scenarios such as a conference room environment with multiple video cameras, it may be desirable to utilize a subset of the video cameras to transmit live video feeds due to the high bandwidth usage of video transmission.

To address these and/or other technical problems associated with traditional AV conferencing systems, various embodiments disclosed herein provide video capture device control based on metadata related to a video environment. For example, one or more machine learning models, one or more digital signal processing (DSP) techniques, and/or one or more other prediction techniques configured to derive characteristics for a video environment may be utilized to generate metadata of video streams. In various examples, the metadata may include machine learning model inference results, DSP insight results, and/or other information related to the video environment. The metadata may be based on video and/or audio related to the video streams. Additionally, the metadata may be transmitted over a network to allow enabling or disabling of respective video capture devices within a video environment. In some examples, the machine learning models may be deployed on the video capture devices and the metadata provided by the machine learning models is transmitted to a hub device that utilizes the metadata to intelligently select which video capture devices to enable in a video environment. The metadata may be additionally or alternatively utilized to intelligently configure the respective video capture devices to, for example, focus on a target of interest (e.g., determine where and/or how to “point” a video capture device to capture the target of interest) in the video environment.

Accordingly, certain machine learning tasks may be offloaded to edge devices while at the same time mitigating inefficient transmission of irrelevant video streams in the video environment. Additionally, based on the metadata, real-time selection and/or composition of video capture devices in a video environment may be provided. Moreover, the metadata may be utilized to optimize video and/or audio dynamics for a video environment to provide a media consumption experience that provides equity for both remote and in-person attendees of the video environment. By utilizing the metadata as disclosed herein, network latency and/or bandwidth utilization for transmitting video data may also be minimized. Additionally, efficiency and/or quality of video processing by a video capture device may be additionally or alternatively improved.

### Example Video Processing Systems and Methods

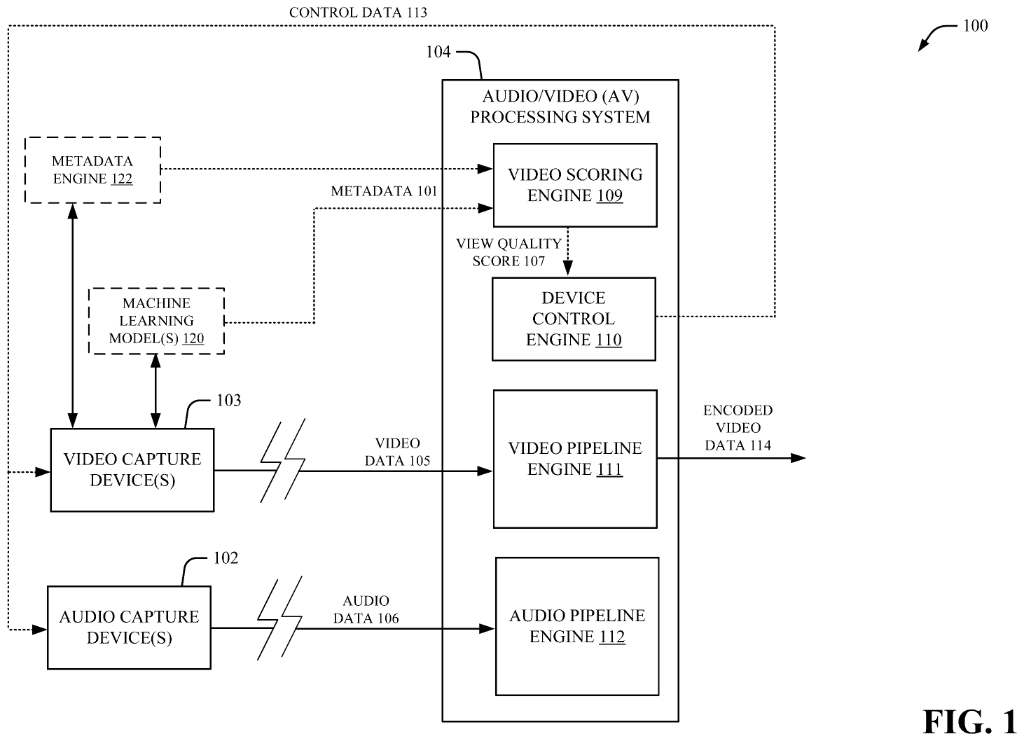

FIG. 1 illustrates a video processing system 100 that is configured to provide a multi-threaded video pipeline for video content related to a video environment, according to embodiments of the present disclosure. For example, the video processing system 100 provides real-time configuration of a video capture devices in a video environment. The video processing system 100 may be, for example, a video environment system, a conferencing system (e.g., a conference audio system, a video conferencing system, an audio video (AV) conferencing system, a digital conference system, etc.), a lecture hall system, a classroom system, a live event system, an automobile advanced driver assistance system (ADAS), a digital media content workstation, a broadcasting system, an augmented reality system, a virtual reality system, a gaming system, an online gaming system, or another type of video system. Additionally, the video processing system 100 may be implemented as a video processing apparatus and/or as software that is configured for execution on a network device, a video capture device (e.g., a camera device), a smartphone, a laptop, a personal computer, a digital conference system, a wireless conference unit, a video workstation device, a communication center device (e.g., a hub device), or another device. The video processing system 100 disclosed herein may additionally or alternatively be integrated into a virtual video processing system (e.g., video processing via virtual processors or virtual machines) with other audio and/or digital signal processing.

By providing real-time configuration of a video capture devices, the video processing system 100 may provide various improvements related to video processing such as, for example: minimizing network latency for transmitting video data over a network, minimizing bandwidth utilization for transmitting video data over a network, reducing a number of computing resources for processing video by a video capture device, and/or improving power consumption for processing video by a video capture device. The video processing system 100 may also be adapted to produce improved video signals for a video environment. Additionally or alternatively, the video processing system 100 may be adapted to produce improved audio for video signals. For example, audio for video signals may be provided with reduced noise, reduced reverberation, improved source separation, and/or a reduction in other undesirable audio artifacts. A video environment may be an indoor environment, an outdoor environment, an entertainment environment, a room, a conference room, a meeting room, a classroom, a lecture hall, a performance hall, a broadcasting environment, a sports stadium or arena, a virtual environment, an automobile environment, or another type of video environment.

In some examples, the video processing system 100 may provide video streams for rendering via one or more display devices. In some examples, a display device may receive a video stream via a physical interface protocol such as a universal serial bus (USB) communication protocols or another type of communication protocol. In some examples, a display device may receive a video stream via a network communication protocol such as an Internet Protocol (IP), IP over Ethernet (IPoE), or other network communication protocol. In some examples, a display device may be a virtual camera or another type of virtual device.

The video processing system 100 includes one or more video capture devices 103. The one or more video capture devices 103 may respectively be devices configured to capture video related to the one or more sound sources and/or one or more entity of interest in a video environment. A sound source may be, for example, a speaker in a conference room. An entity of interest may be, for example, a whiteboard surface or a non-speaking person in a conference room. The one or more video capture devices 103 may include one or more sensors configured for capturing video by converting light into one or more electrical signals. The video captured by the one or more video capture devices 103 may also be converted into video data 105. In an example, the one or more video capture devices 103 are one or more video cameras.

In some examples, the video processing system 100 additionally includes one or more audio capture devices 102. The one or more audio capture devices 102 may respectively be devices configured to capture audio from one or more sound sources. The one or more audio capture devices 102 may include one or more sensors configured for capturing audio by converting sound into one or more electrical signals. The audio captured by the one or more audio capture devices 102 may also be converted into audio data 106. The audio data 106 may be a digital audio data or, alternatively, analog audio data, related to the one or more electrical signals. In some examples, the audio data 106 may be beamformed audio data.

In an example, the one or more audio capture devices 102 are one or more microphones arrays. For example, the one or more audio capture devices 102 may correspond to one or more array microphones, one or more beamformed lobes of an array microphone, one or more linear array microphones, one or more ceiling array microphones, one or more table array microphones, or another type of array microphone. In alternate examples, the one or more audio capture devices 102 are another type of capture device such as, but not limited to, one or more condenser microphones, one or more micro-electromechanical systems (MEMS) microphones, one or more dynamic microphones, one or more piezoelectric microphones, one or more virtual microphones, one or more network microphones, one or more ribbon microphones, and/or another type of microphone configured to capture audio. It is to be appreciated that, in certain examples, the one or more audio capture devices 102 may additionally or alternatively include one or more infrared capture devices, one or more sensor devices, one or more video capture devices (e.g., one or more video capture devices 103), and/or one or more other types of audio capture devices.

The one or more video capture devices 103 and/or the one or more audio capture devices 102 may be positioned within a particular video environment. In some examples, the video data 105 includes video frames related to a speaker associated with the audio data 106. In some examples, the one or more video capture devices 103 and the one or more audio capture devices 102 may be integrated together in one or more capture devices.

The video processing system 100 also comprises an audio/video (AV) processing system 104. The AV processing system 104 may be configured to perform one or more video processes and/or one or more audio processes with respect to the video data 105 and/or the audio data 106 to provide encoded video data 114. The AV processing system 104 depicted in FIG. 1 includes a video scoring engine 109, device control engine 110, a video pipeline engine 111, and/or an audio pipeline engine 112.

The video scoring engine 109 utilizes metadata 101 provided by one or more machine learning models 120 and/or a metadata engine 122 to generate a view quality score 107 related to the one or more video capture devices 103. The view quality score may refer to a numerical or categorical value that represents quality of a view captured by the one or more video capture device 103. The quality of the view may be determined with respect to one or more targets of interest in the video environment. In some examples, the view quality score 107 may be generated based on one or more features extracted from the metadata 101, the video data 105, and/or the audio data 106. In some examples, the view quality score 107 may be utilized to compare and/or rank different views or camera angles within the video environment. In some examples, the view quality score 107 may be utilized to determine optimal camera selection, optimal framing, optimal configuration, and/or other optimal control of the one or more video capture device 103 or multiple video capture devices 103 in a multi-camera system.

The one or more machine learning models 120 may include one or more video machine learning models and/or one or more audio machine learning models to generate at least a portion of the metadata 101. In some examples, the one or more machine learning models 120 may respectively be configured as a neural network model, a deep learning model, a convolutional neural network model, and/or another type of machine learning models. The metadata 101 provided by the one or more machine learning models 120 may include one or more inferences with respect to the video data 105 and/or the audio data 106. The metadata engine 122 may perform one or more DSP techniques and/or one or more other prediction techniques that do not involve machine learning to generate at least a portion of the metadata 101. For example, the metadata engine 122 may determine an average brightness or other quality determinations for a video frame, provide a group eye gaze prediction related to video frames, etc. In another example, the metadata engine 122 may detect motion or proximity of a person in the video environment based on sensor data provided by one or more sensors of the one or more video capture devices 103. The sensor data may include motion sensor data, proximity sensor data, radar sensor data, LiDAR sensor data, time-of-flight (TOF) sensor data, and/or other sensor data to facilitate detection of a person or object in the video environment. In some examples, the metadata 101 may be related to events with respect to the video data 105 and/or the audio data 106. In some examples, the metadata 101 may be related to events with respect to raw video data and/or raw audio data. For example, the events may be with respect to video data related to the one or more video capture devices 103, audio data related to the one or more audio capture devices 102, sensor data provided by one or more sensors of at least one video capture device of the one or more video capture devices 103, sensor data provided by at least one audio capture device of the one or more audio capture devices 102, and/or machine learning model output provided by the one or more machine learning models 120. In some examples, the raw video data related to the one or more video capture devices 103 may include video data and audio data. Additionally, the metadata 101 may be formatted to assist with view quality scoring and/or control of the one or more video capture devices 103.

In some examples, the one or more machine learning models 120 may include one or more machine learning models such as a head pose estimation model that computes a rotational matrix of a detected human face, a face detection model that detects a face in a video frame, an eye gaze estimation model that provides eye tracking with respect to a face in a video frame, a person detection model that detects one or more people in a video frame, an identity detection model that predicts an identity of one or more people in a video frame, an active speaker recognition model that predicts an active speaker in a video frame, an object detection model that detects one or more objects in a video frame, an emotion detection model that predicts a type of emotion related to one or more people in a video frame, a sentiment model that predicts a type of sentiment related to one or more people in a video frame, a noise level prediction model that predicts a degree of noise related to a video frame, a speech detection model that detects speech audio related to a video frame, an audio event model that detects certain types of audio events (e.g., clapping, snapping, whispering, etc.) related to a video frame, a sound source model that classifies a type of sound associated with a sound source related to a video frame, and/or one or more other types of machine learning models. In some examples, a person detected by the person detection model and/or an object detected by the object detection model may be designated for further tracking and/or video processing via one or more future video frames based on audio, sentiment, emotion, interaction events, noise volume, audio classifications, user selection, and/or one or more other criteria related to the person and/or object. In some examples, a person detected by the person detection model and/or an object detected by the object detection model may be designated for further tracking and/or video processing via one or more future video frames based on one or more detected actions with respect to the person and/or object. In a non-limiting example, a whiteboard in a video environment may be designated for further tracking and/or video processing in response to a determination that one or more people are using the whiteboard.

In some examples, the metadata 101 may include a feature set related to the video data 105 and/or the audio data 106. One or more features from the feature set may be extracted from one or more video frames related to the video data 105 and/or one or more audio signals related to the audio data 106. The feature set may include one or more features such as, but not limited to: video features, features related to video frames, object detection features, object classifications, face recognition features, person recognition features, person classifications, three-dimensional coordinates, facial features, mouth features, head pose features, head pose angles, eye features, eye gaze angles, emotion predictions, active speaking classifications, camera locations, camera poses, depth estimation, audio features, and/or one or more other features. In some examples, the feature set is a video feature set that includes one or more features extracted from one or more video frames related to the video data 105. The video feature set may include visual information related to one or more video frames of the video data 105 such as: object detection information, facial features, motion patterns, color distributions, texture information, and/or other visual features represented by one or more video frames of the video data 105. In some examples, the video feature set may be generated by applying one or more: image processing techniques, computer vision techniques, and/or machine learning techniques to analyze content of the one or more video frames. In some examples, the feature set is a gaze detection feature set that includes one or more eye features, eye gaze angles, or other gaze detection features provided by the one or more machine learning models 120 and/or the metadata engine 122.

In some examples, the video scoring engine 109 generates the view quality score 107 based on respective features included in the metadata 101. In a non-limiting example, where a head pose estimation model of the one or more machine learning models 120 computes a rotational matrix of a detected human face, the metadata 101 may include a yaw angle that extracted from the rotational matrix. The video scoring engine 109 may compare the yaw angle to one or more other yaw angles for one or more other video capture devices in the video environment to determine the view quality score 107.

In some examples, the video scoring engine 109 weights the respective features included in the metadata 101 to determine the view quality score 107. For example, the view quality score 107 may be a weighted combination of extracted features related to the metadata 101. Additionally, the video scoring engine 109 may generate the view quality score 107 for each detected face in the video data 105.

The weights of the scoring technique utilized by the video scoring engine 109 may depend on a rules set for determining a quality view for a video environment. For example, a weight may correspond to a relative importance of a particular feature included in the metadata 101 after adjusting for differences in scaling of features. The rules set may establish rules related to relationships between features and/or independence of features. For example, the rules set may indicate that nonlinear relationships between features cannot be modeled and/or that one or more features in the metadata 101 are independent with respect to one or more other features in the metadata.

In some examples, the rules set may establish one or more rules for a particular video environment, a person associated with a digital identifier, and/or a particular object. For example, a first weighting configuration may be beneficial for a first video environment and a second weighting configuration may be beneficial for a second video environment. As such, the rules set may tune weights for a specific use case related to a video environment, a person associated with a digital identifier, and/or a particular object. In a non-limiting example, the rules set may tune weights based on a size of a video environment (e.g., a size of a room) and/or a number of people detected in the video environment. Additionally or alternatively, the rules set may include one or more thresholds and/or rules for thresholds related to different features. In a non-limiting example, the rules set may alter the view quality score 107 if a particular feature such as a head pose feature is greater than a defined threshold value. In some examples, the rules set may disregard a particular weight if the weighting of a feature exceeds a defined threshold value. For instance, if a weight adjustment of a particular feature results in a weighted value that is above a defined threshold value, the rules set may select the original value of the feature prior to the weighting rather than the weighted value.

In some examples, the view quality score 107 may enable ranking of video capture devices 103 for a particular person or object in the video environment such that a highest ranked video capture device 103 may provide an optimal view with respect to the person or object in the video environment. In some examples, a higher view quality score 107 may correspond to a scenario where a target individual represented in the video data 105 is more frontal (e.g., a head pose angle is closer to zero) and/or more visible with respect to one or more individual or objects represented in the video data 105.

The device control engine 110 utilizes the view quality score 107 to determine control data for the one or more video capture devices 103. In some examples, the device control engine 110 transmits the control data 113 to the one or more video capture devices 103 to configure and/or control the one or more video capture devices 103. For example, the control data 113 may be utilized to control and/or configure one or more portions of the one or more video capture devices 103. In some examples, the control data 113 may be additionally utilized to control and/or configure one or more machine learning models of the one or more machine learning models 120.

In some examples, the control data 113 may include one or more configuration parameters (e.g., a configuration parameter set) for the one or more video capture devices 103 such as, but not limited to one or more: camera settings, camera selection, camera focus direction, pan, zoom, crop, microphone array settings, beam steering settings, video encoding settings, video frame transmission settings, video frame size, frame rate, color depth settings, resolution format settings, and/or another type of configuration parameter for the one or more video capture devices 103.

In some examples, the control data 113 may enable or disable one or more functionalities associated with the one or more video capture devices 103. For instance, the control data 113 may include one or more control signals and/or configuration data to enable or disable one or more video processing tasks. A video processing task may include camera data acquisition, video encoding/decoding, video machine learning modeling, or another type of video processing task. Additionally, a video processing task may result in generation of metadata, video metrics, object detection, and/or people detection associated with video frames. In some examples, the control data 113 may be additionally or alternatively utilized to: initiate feature extraction with respect to video data, configure parameters or types of features to be extracted, etc.

The video pipeline engine 111 utilizes the one or more video capture devices 103 configured and/or controlled based on the control data 113 to provide encoded video data 114 related to the one or more video capture devices 103. In some examples, respective video processors related to the one or more video capture devices 103 are configured and/or control based on the control data 113. In some examples, respective video processing threads are configured and/or control based on the control data 113. Configuration of the one or more video capture devices 103 may include: turning particular video processing threads on or off, setting particular parameters for particular video processing threads, initiating particular video related tasks, initiating particular type of encoding task, initiating a video data acquisition task, initiating execution of one a particular machine learning model, and/or one or more other types of configurations for a video processing thread. Based on the configuration of the respective video capture devices 103, the video pipeline engine 111 may encode video data related to the one or more video capture devices 103 to generate the encoded video data 114.

In some examples, the video pipeline engine 111 utilizes the one or more video capture devices 103 configured and/or controlled based on the control data 113 to intelligently switch and/or compose views for a video stream provided by the one or more video capture devices. In some examples, the control data includes a cinematography identifier for a cinematography technique for utilization by the one or more video capture devices 103. The cinematography identifier may indicate a particular type of cinematography operation to perform with respect to one or more video frames such as, for example, zooming or panning with respect to a person or object within a field of view of a video capture device.

In some examples, the video pipeline engine 111 outputs the encoded video data 114 to a network device. The network device may be a network switch, a user device, a display device, an edge device, or another type of device communicatively coupled to the video processing system 100 via a network. The network may be a communication network or any suitable network or combination of networks that supports any appropriate protocol suitable for communication of the encoded video data 114 to and from devices. For example, the network may utilize a network communication protocol such as IP, IPoE, or other network communication protocol to transmit the encoded video data 114 via IP datagrams. In some examples, the network may transmit the encoded video data 114 via one or more network layers such as a data link layer. In some examples, the encoded video data 114 may be encapsulated according to a network communication protocol to provide encapsulated video data packets. In some examples, the network is implemented as the Internet, a wireless network, a wired network (e.g., Ethernet), a local area network (LAN), a Wide Area Network (WANs), Bluetooth, Near Field Communication (NFC), or any other type of network that provides communications between one or more components of a network architecture.

Accordingly, the AV processing system 104 may provide improved video processing as compared to traditional video processing techniques. The AV processing system 104 may additionally or alternatively provide improved audio for the video environment. For example, the encoded video data 114 may be provided with improved accuracy of localization of a sound source in the video environment. The encoded video data 114 may be additionally or alternatively provided with improved audio signals with reduced noise, reverberation, and/or other undesirable audio artifacts even in view of exacting video latency requirements for the encoded video data 114. For example, the AV processing system 104 may remove or suppress undesirable noise for noise locations in the video environment to provide the encoded video data 114.

The AV processing system 104 may also employ fewer computing resources when compared to traditional video processing systems that are used for video processing. Additionally or alternatively, the AV processing system 104 may be configured to deploy a smaller number of memory resources allocated to video processing, beamforming, source separation, denoising, dereverberation, and/or other audio processing for the encoded video data 114. In some examples, the AV processing system 104 may be configured to improve processing speed of video processing operations, beamforming operations, source separation operations, denoising operations, dereverberation operations, and/or audio filtering operations. These improvements may enable an improved AV processing systems to be deployed with respect to cameras, microphones or other hardware/software configurations where processing and memory resources are limited, and/or where processing speed and efficiency is important.

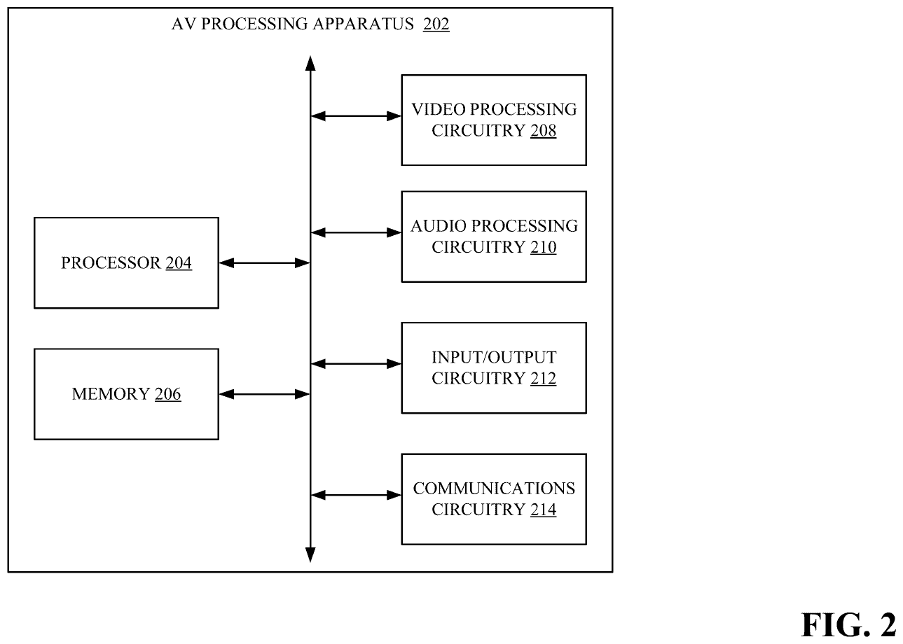

FIG. 2 illustrates an example AV processing apparatus 202 configured in accordance with one or more embodiments of the present disclosure. The AV processing apparatus 202 may be configured to perform one or more techniques described in FIG. 1 and/or one or more other techniques described herein.

The AV processing apparatus 202 may be a computing system communicatively coupled with one or more circuit modules related to video processing and/or audio processing. The AV processing apparatus 202 may comprise or otherwise be in communication with a processor 204, a memory 206, video processing circuitry 208, audio processing circuitry 210, input/output circuitry 212, and/or communications circuitry 214. In some embodiments, the processor 204 (which may comprise multiple or co-processors or any other processing circuitry associated with the processor) may be in communication with the memory 206.

The memory 206 may comprise non-transitory memory circuitry and may comprise one or more volatile and/or non-volatile memories. In some examples, the memory 206 may be an electronic storage device (e.g., a computer readable storage medium) configured to store data that may be retrievable by the processor 204. In some examples, the data stored in the memory 206 may comprise video data, audio data, stereo audio signal data, mono audio signal data, radio frequency signal data, audio features, video features, control data, machine learning data, defined event type data, or the like, for enabling the AV processing apparatus 202 to carry out various functions or methods in accordance with embodiments of the present disclosure, described herein.

In some examples, the processor 204 may be embodied in a number of different ways. For example, the processor 204 may be embodied as one or more of various hardware processing means such as a central processing unit (CPU), a microprocessor, a coprocessor, a DSP, a field programmable gate array (FPGA), a neural processing unit (NPU), a graphics processing unit (GPU), a system on chip (SoC), a cloud server processing element, a controller, or a processing element with or without an accompanying DSP. The processor 204 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some embodiments, the processor 204 may comprise one or more processing cores configured to perform independently. A multi-core processor may enable multiprocessing within a single physical package. Additionally or alternatively, the processor 204 may comprise one or more processors configured in tandem via a bus to enable independent execution of instructions, pipelining, and/or multithreading.

In some examples, the processor 204 may be configured to execute instructions, such as computer program code or instructions, stored in the memory 206 or otherwise accessible to the processor 204. Alternatively or additionally, the processor 204 may be configured to execute hard-coded functionality. As such, whether configured by hardware or software instructions, or by a combination thereof, the processor 204 may represent a computing entity (e.g., physically embodied in circuitry) configured to perform operations according to an embodiment of the present disclosure described herein. For example, when the processor 204 is embodied as an CPU, DSP, ARM, FPGA, ASIC, or similar, the processor may be configured as hardware for conducting the operations of an embodiment of the disclosure. Alternatively, when the processor 204 is embodied to execute software or computer program instructions, the instructions may specifically configure the processor 204 to perform the algorithms and/or operations described herein when the instructions are executed. However, in some examples, the processor 204 may be a processor of a device specifically configured to employ an embodiment of the present disclosure by further configuration of the processor using instructions for performing the algorithms and/or operations described herein. The processor 204 may further comprise a clock, an arithmetic logic unit (ALU) and logic gates configured to support operation of the processor 204, among other things.

In one or more examples, the AV processing apparatus 202 includes the video processing circuitry 208. The video processing circuitry 208 may be any means embodied in either hardware or a combination of hardware and software that is configured to perform one or more functions disclosed herein related to the video scoring engine 109, the device control engine 110, and/or the video pipeline engine 111. For example, the video processing circuitry 208 may be any means embodied in either hardware or a combination of hardware and software that is configured to perform one or more functions disclosed herein related to processing of the metadata 101 received from the one or more machine learning models 120 and/or processing of the video data 105 received from the one or more video capture devices 103. In one or more examples, the AV processing apparatus 202 includes the audio processing circuitry 210. The audio processing circuitry 210 may be any means embodied in either hardware or a combination of hardware and software that is configured to perform one or more functions disclosed herein related to the audio pipeline engine 112 and/or other audio processing of the audio data 106 received from the one or more audio capture devices 102.

In some examples, the AV processing apparatus 202 includes the input/output circuitry 212 that may, in turn, be in communication with processor 204 to provide output to the user and, in some examples, to receive an indication of a user input. The input/output circuitry 212 may comprise a user interface and may comprise a display. In some examples, the input/output circuitry 212 may also comprise a keyboard, a touch screen, touch areas, soft keys, buttons, knobs, or other input/output mechanisms.

In some examples, the AV processing apparatus 202 includes the communications circuitry 214. The communications circuitry 214 may be any means embodied in either hardware or a combination of hardware and software that is configured to receive and/or transmit data from/to a network and/or any other device or module in communication with the AV processing apparatus 202. In this regard, the communications circuitry 214 may comprise, for example, an antenna or one or more other communication devices for enabling communications with a wired or wireless communication network. For example, the communications circuitry 214 may comprise antennae, one or more network interface cards, buses, switches, routers, modems, and supporting hardware and/or software, or any other device suitable for enabling communications via a network. Additionally or alternatively, the communications circuitry 214 may comprise the circuitry for interacting with the antenna/antennae to cause transmission of signals via the antenna/antennae or to handle receipt of signals received via the antenna/antennae.

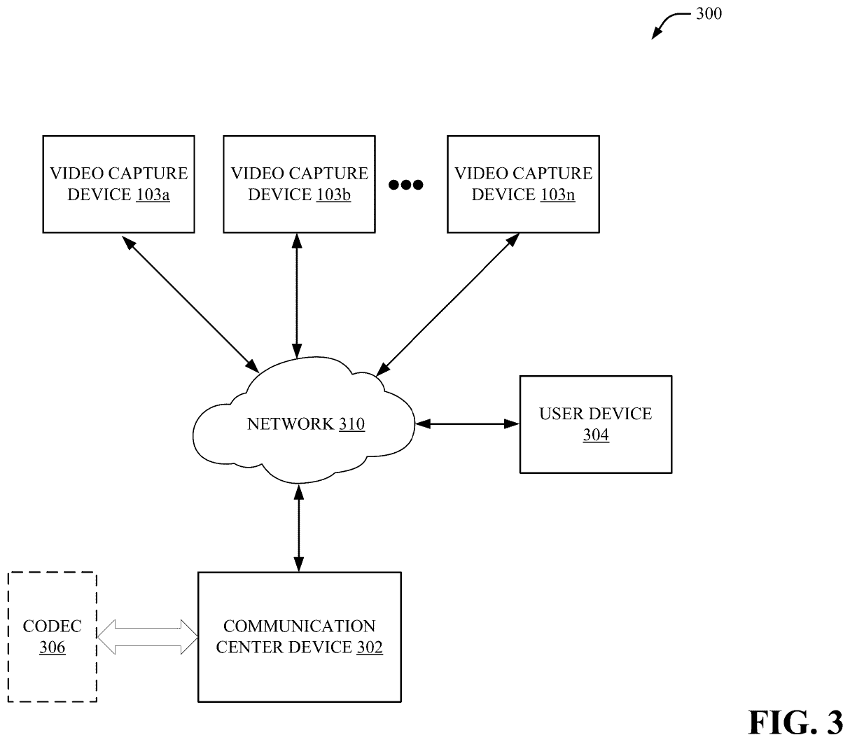

FIG. 3 illustrates a network system 300 according to one or more embodiments of the present disclosure. The network system 300 includes the one or more video capture devices 103 (e.g., video capture devices 103a-n), a communication center device 302, and/or a user device 304. In some examples, at least one of the one or more video capture devices 103 includes the AV processing system 104 and/or the AV processing apparatus 202. Alternatively, in some examples, the communication center device 302 includes the AV processing system 104 and/or the AV processing apparatus 202. In some examples, the communication center device 302 includes the AV processing system 104 and/or the AV processing apparatus 202. The one or more video capture devices 103, the communication center device 302, and/or the user device 304 may be communicatively coupled via a network 310. In some examples, the network 310 includes one or more network devices such as one or more network switches and/or one or more network routers. The communication center device 302 may be a hub device that supports Ethernet, voice over Internet Protocol (VOIP), and/or one or more network communication protocols. In some examples, the communication center device 302 may enable the one or more video capture devices 103 to be configured as a set of network-connected video devices for a video environment.

The communication center device 302 may provide video and/or audio from the one or more video capture devices 103 to the user device 304. In some examples, the user device 304 may be configured as a host device for a video conference enabled by the one or more video capture devices 103 and the communication center device 302. For instance, the user device 304 may be configured as a host of a codec 306 that receives a video stream (e.g., the encoded video data 114) provided by the one or more video capture device 103. In some examples, the codec 306 is a video conference codec configured for video conferencing. The user device 304 may be communicatively coupled to the communication center device 302 via the network 410 or another direct IP connection. Alternatively, the user device 304 may be communicatively coupled to the communication center device 302 via a direct wired connection such as a USB connection or another type of hardware interface that supports a display protocol. In some examples, the user device 304 may also be communicatively coupled to the one or more video capture devices 103 via the network 310. In some examples, the user device 304 may correspond to the communication center device 302 such that the user device 304 manages video and/or audio from the one or more video capture devices 103. In such examples, the user device 304 includes the AV processing system 104 and/or the AV processing apparatus 202. In some examples, the user device 304 may additionally or alternatively be configured as a video capture device. As such, video and/or audio from the user device 304 may be provided in addition to video and/or audio from one or more video capture devices 103.

The user device 304 may be a smartphone, a laptop, a personal computer, a digital conference device, a wireless conference unit, an augmented reality device, a virtual reality device, or another type of user device. In some examples, the user device 304 includes a display and/or a graphical user interface that renders video content provided by the one or more video capture devices 103. In some examples, the user device 304 may provide a virtual video capture device and/or a virtual audio capture device for the network system 300. Additionally, video and/or audio from the virtual devices may be routed to the codec 306 in addition to video and/or audio from one or more video capture devices 103.

In some examples, the user device 304 may provide user device data to the communication center device 302 and/or the one or more video capture devices 103 to facilitate interactions with the communication center device 302 and/or the one or more video capture devices 103. The user device data may include data such as, but not limited to: supported video formats, network interface card (NIC) bandwidth, a role identifier (e.g., hub or video capture device), a device identifier (e.g., a media access control (MAC) address or another type of identifier), a user identifier, and/or other data related to the user device 304. In some examples, one or more portions of the user device data may be provided via an electronic interface of the user device 304. Additionally or alternatively, one or more portions of the user device data may be provided via metadata or a user device profile for the user device 304.

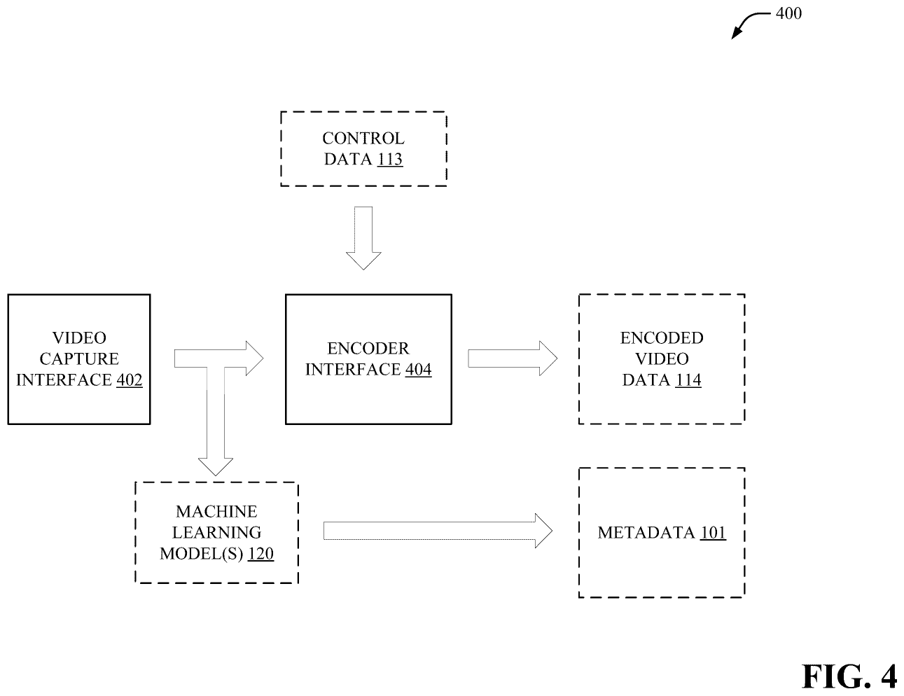

FIG. 4 illustrates a transmitter system 400 according to one or more embodiments of the present disclosure. The transmitter system 400 may be included in and/or otherwise associated with the one or more video capture devices 103. In some examples, the video pipeline engine 111 may include the transmitter system 400. The transmitter system 400 includes a video capture interface 402 and/or an encoder interface 404. The video capture interface 402 may capture and/or receive one or more portions of video data (e.g., the video data 105) associated with the one or more video capture devices 103. The one or more portions of the video data (e.g., the video data 105) captured and/or received by the video capture interface 402 may be raw video data. In some examples, the video capture interface 402 includes one or more imagers such as one or more camera lenses and/or one or more sensors to capture the video data 105. In some examples, the video capture interface 402 may utilize a communication protocol and/or a communication connection such as a USB connection, a camera serial interface (CSI) connection, a peripheral component interconnect express (PCIe) connection, an IP connection, or another type of connection to couple the video capture interface 402 to the encoder interface 404.

The encoder interface 404 may encode the video data captured and/or received by the video capture interface 402. In some examples, the encoder interface 404 may transform the video data captured and/or received by the video capture interface 402 into one or more portions of the encoded video data 114. The encoder interface 404 may also act as an interface between the one or more video capture devices 103 and the network 310. In some examples, the encoder interface 404 may be configured and/or controlled based on the control data 113. In some examples, the encoder interface 404 may encode video data via a particular encoding mode (e.g., a first mode for encoding and not transmitting video, a second mode for encoding and transmitting video data, or a third mode for not encoding and not transmitting video data) based on the control data 113. In some examples, the encoder interface 404 may configure the one or more portions of the encoded video data 114 as video data packets (e.g., IP datagrams) for transmission via the network 310. For instance, the encoder interface 404 may reformat the video data captured and/or received by the video capture interface 402 into video data IP datagrams by encapsulating the video data IP datagrams via Ethernet frames. In some examples, the encoded video data 114 may include audio data and/or may be synchronized with the audio pipeline engine 112. In some examples, the one or more machine learning models 120 may extract one or more portions of the metadata 101 from the video data captured and/or received by the video capture interface 402. In some examples, the control data 113 may be determined based on the metadata 101.

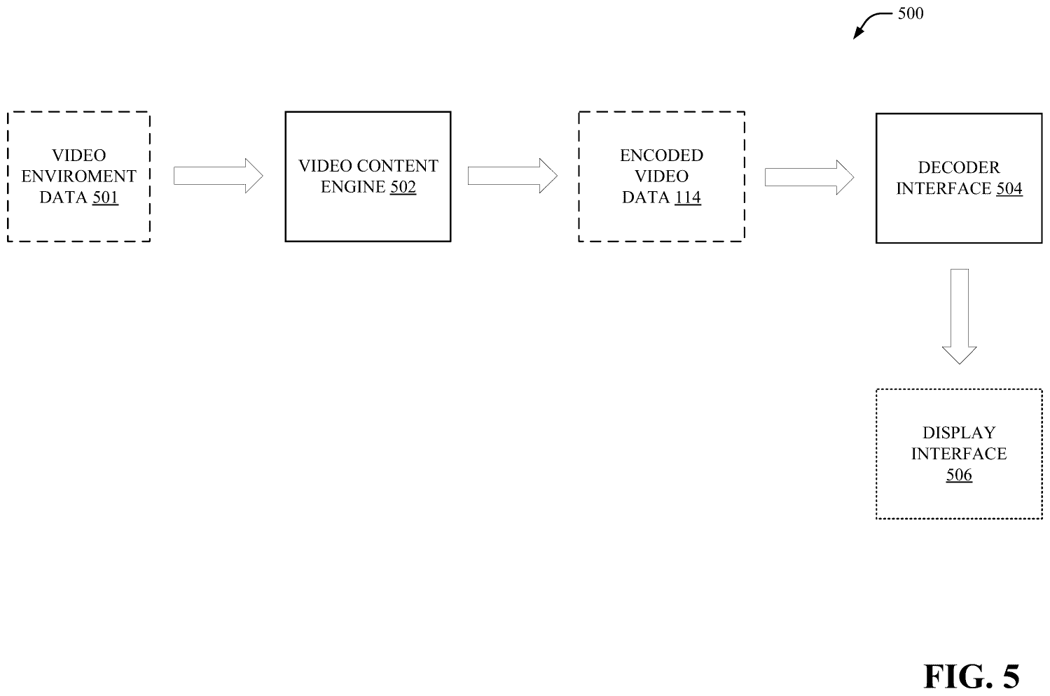

FIG. 5 illustrates a receiver system 500 according to one or more embodiments of the present disclosure. The receiver system 500 may be included in and/or otherwise associated with the communication center device 302. The receiver system 500 includes a video content engine 502 and/or a decoder interface 504. The video content engine 502 may receive network content from respective video capture devices and/or machine learning models in a video environment. The network content may include metadata, video content, audio content, and/or other content provided by respective video capture devices and/or machine learning models. The video content engine 502 may also provide video data based on the network content received from the content from respective video capture devices. In an example, the video content engine 502 may receive video environment data 501. In some examples, the video environment data 501 may include the encoded video data 114 provided by the AV processing system 104. As such, the video content engine 502 may provide the encoded video data 114. In some examples, the video content engine 502 may provide the encoded video data 114 based on the video environment data 501. For example, the video content engine 502 may extract a payload that includes the encoded video data 114 from the video environment data 501.

In some examples, the video environment data 501 includes multiple captures of a person (e.g., person associated with a digital identifier) from different angles provided by different video capture devices. In some examples, the video environment data 501 additionally or alternatively includes a predicted view quality score (e.g., the view quality score 107) for each of the viewing angles. As such, the video content engine 502 may determine which viewing angle is an optimal viewing angle such that a corresponding portion of the encoded video data 114 (e.g., corresponding encoded video frames) are provided to the decoder interface 504.

The encoded video data 114 may be provided to the decoder interface 504 to transform the encoded video data 114 into decoded video content for rendering via a display interface 506. In some examples, the decoder interface 504 may determine decoding parameters, frame types, and/or other decoding information for video frames from the encoded video data 114. The display interface 506 may be a display and/or a graphical user interface of a user device (e.g., the user device 304).

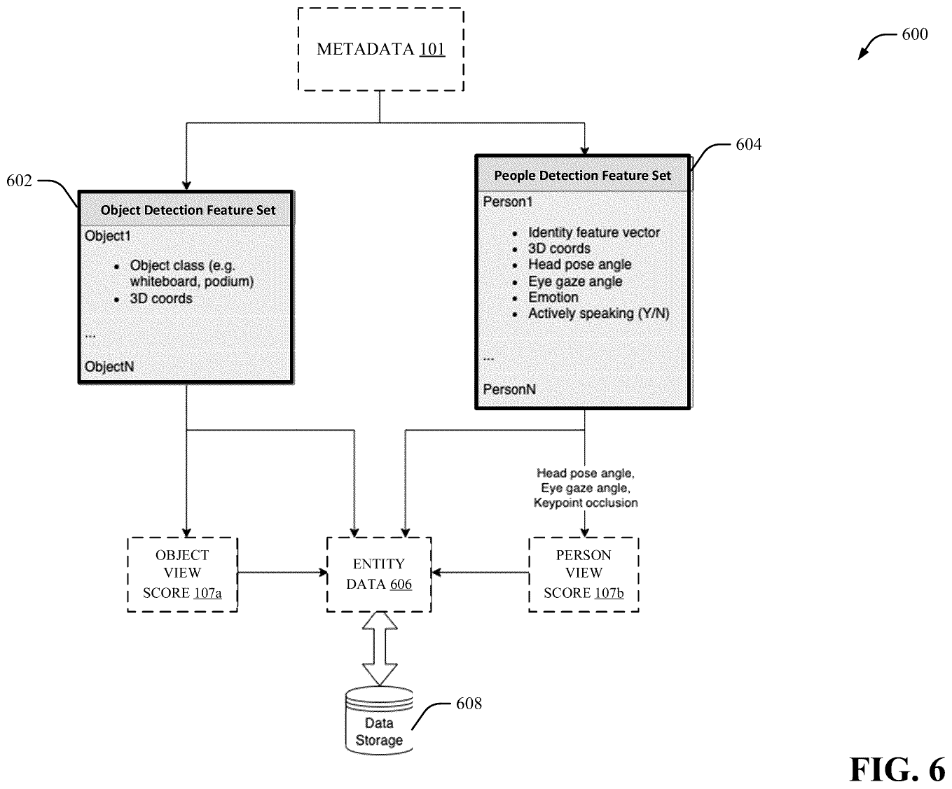

FIG. 6 illustrates a score computation architecture 600 according to one or more embodiments of the present disclosure. The score computation architecture 600 may be related to the video scoring engine 109. In some examples, the metadata 101 includes an object detection feature set 602 and/or a people detection feature set 604. The object detection feature set 602 may include one or more features related to one or more objects in a video environment associated with the metadata 101. For example, the object detection feature set 602 may include one or more features related to an object such as, but not limited to: an object classification, three-dimensional coordinates, object detection features, spatial features, motion features, and/or one or more other features. The people detection feature set 604 may include one or more features related to one or more persons of interest in a video environment associated with the metadata 101. For example, the people detection feature set 604 may include one or more features related to a person such as, but not limited to: face recognition features, person recognition features, person classifications, three-dimensional coordinates, facial features, mouth features, head pose features, head pose angles, eye features, eye gaze angles, emotion predictions, active speaking classifications, and/or one or more other features. In some examples, the object detection feature set 602 may be formatted as an object feature vector and/or the people detection feature set 604 may be formatted as an identity feature vector.

In some examples, the video scoring engine 109 may generate an object view score 107a based on the object detection feature set 602. The object view score 107a may refer to a numerical or categorical value that represents quality of a view for an object captured by the one or more video capture device 103. For example, the object view score 107a may be determined with respect to an object in the video environment. Additionally or alternatively, the video scoring engine 109 may generate a person view score 107b based on the object detection feature set 602. The person view score 107b may refer to a numerical or categorical value that represents quality of a view for a person captured by the one or more video capture device 103. For example, the person view score 107b may be determined with respect to a person in the video environment. In some examples, the view quality score 107 includes and/or is determined based on the object view score 107a and/or the person view score 107b. In some examples, the video scoring engine 109 generates the object view score 107a based on respective features included in the object detection feature set 602. In some examples, the video scoring engine 109 weights the respective features included in the object detection feature set 602 to determine the object view score 107a. For example, the object view score 107a may be a weighted combination of extracted features related to the object detection feature set 602. In some examples, the object view score 107a and/or the person view score 107b may be based on a size of a detection area for a corresponding object or person. For example, the object view score 107a and/or the person view score 107b may be weighted based on an area of a bounding box in a video frame for a corresponding object or person. In some examples, a weight associated with a bounding box may scale a size value of the bounding box. In some examples, a view score for a person or object may include the scaled size value of the bounding box. In some examples, a weight associated with a bounding box may be based on parameters for the video environment such as, but not limited to, a size of the video environment, a number of people detected in the video environment, a type of object or person associated with the bounding box, etc.

In some examples, the video scoring engine 109 generates the person view score 107b based on respective features included in the people detection feature set 604. In some examples, the video scoring engine 109 weights the respective features included in the people detection feature set 604 to determine the person view score 107b. For example, the person view score 107b may be a weighted combination of extracted features related to the people detection feature set 604. In some examples, the video scoring engine 109 may correlate the object view score 107a and/or the person view score 107b with entity data 606 related to an entity of interest in one or more video frames. In some examples, the video scoring engine 109 may store the entity data 606 in a data storage 608. The data storage 608 may correspond to the memory 206 or another storage communicatively coupled to the video scoring engine 109. In some examples, the device control engine 110 may utilize the entity data 606 to generate one or more portions of the control data 113 to focus on and/or determine a best view for the object and/or the entity of interest. In some examples, the video scoring engine 109 may store the entity data 606 in a data storage 608 based on 3D coordinates, object classifications, and/or person classifications related to the entity data 606. For example, the video scoring engine 109 may update and/or create data for a particular 3D coordinate, object classification, and/or person classification in a video environment based on the 3D coordinates, object classifications, and/or person classifications related to the entity data 606.

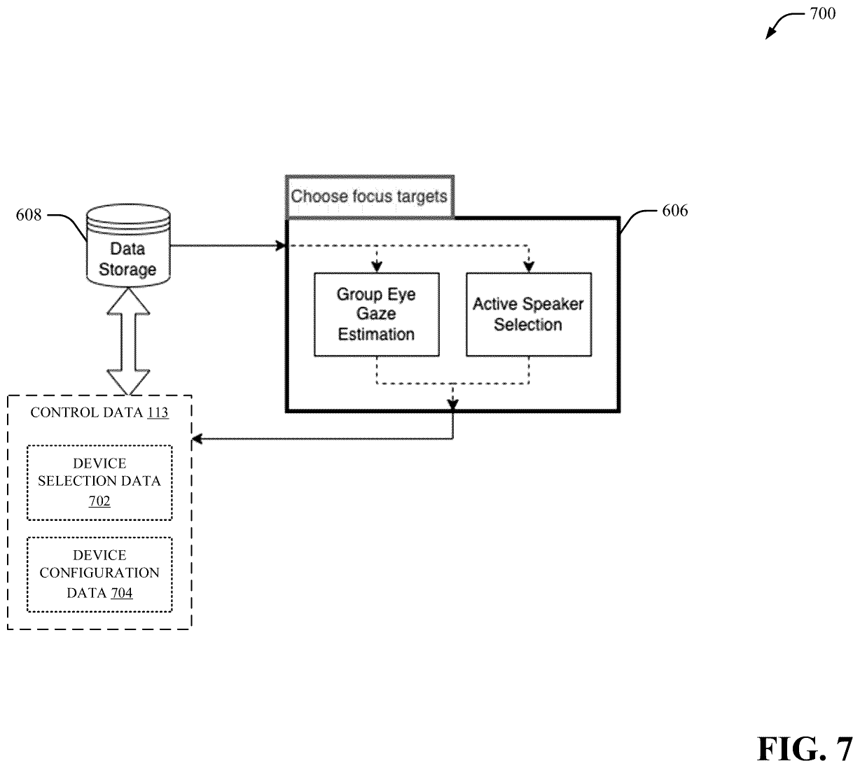

FIG. 7 illustrates a device control architecture 700 according to one or more embodiments of the present disclosure. The device control architecture 700 may be related to the device control engine 110. In some examples, the device control engine 110 utilizes the entity data 606 stored in the data storage 608 to generate one or more portions of the control data 113. For example, the device control engine 110 may utilize a group eye gaze estimation and/or an active speaker selection associated with the entity data 606 to generate one or more portions of the control data 113. The group eye gaze estimation may infer where a person in a video environment is looking. For example, if a person is looking in a direction of a particular detected object such as a whiteboard in the video environment, the whiteboard may be selected as a focus target. In some examples, the group eye gaze estimation may be computed based on features such as eye gaze angle, 3D coordinates, etc. The active speaker selection may select a focus target predicted to be an active speaker in the video environment. In some examples, the active speaker selection may be computed based on an active speaking classification.

In some examples, the control data 113 includes device selection data 702 and/or device configuration data 704. The device selection data 702 may include a video capture device identifier that corresponds to a video capture device 103 to be selected for operation in the video environment. The device configuration data 704 may include one or more configuration parameters for one or more video capture devices 103. For example, the device configuration data 704 may include one or more: camera settings, exposure, white balance, color temperature, camera selection, camera mode selection, camera focus direction, pan, zoom, crop, microphone selection, microphone array settings, beam steering settings, speech separation, video encoding settings, video frame transmission settings, video frame size, frame rate, color depth settings, resolution format settings, machine learning model settings, metadata selection settings, optical character recognition (OCR) settings, and/or another type of configuration parameter for the one or more video capture devices 103. In some examples, the device selection data 702 may select an optimal video capture device 103 for a focus target. In some examples, the device configuration data 704 may control a video capture device 103 and/or a related video stream from a selected video capture device identified in the device selection data 702.

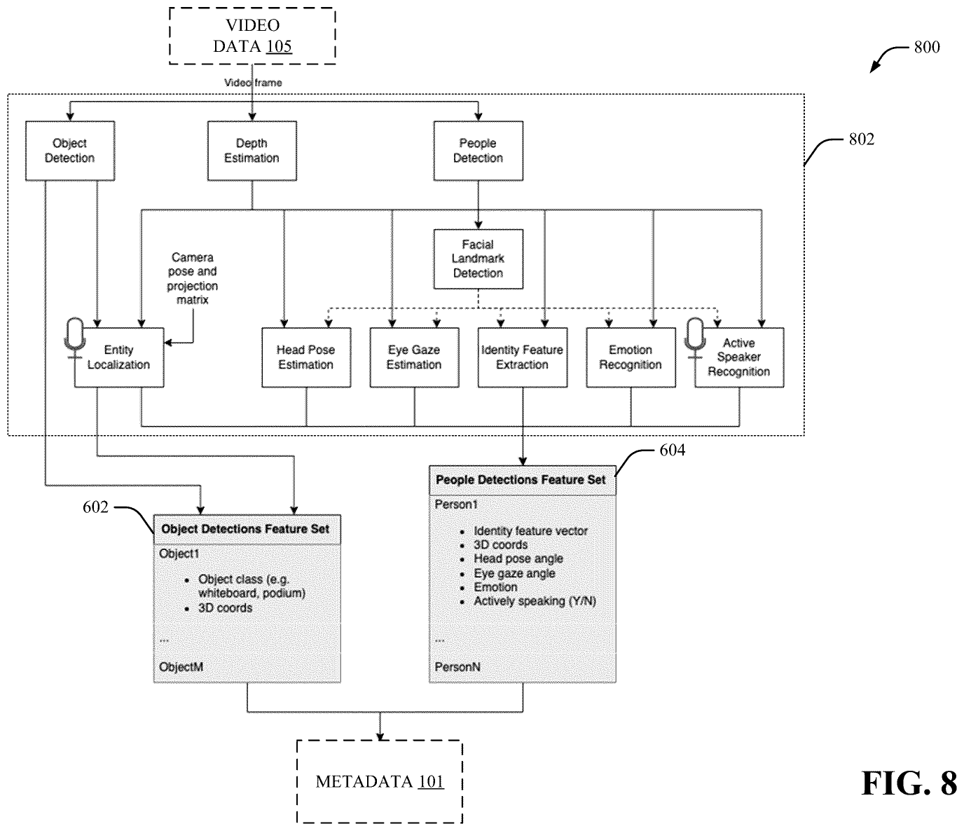

FIG. 8 illustrates a machine learning architecture 800 according to one or more embodiments of the present disclosure. The machine learning architecture 800 may be related to the one or more machine learning models 120. In some examples, the one or more machine learning models 120 may provide one or more features 802 extracted from one or more video frames of the video data 105. The one or more features 802 may be related to object detection, depth estimation, people detection, entity localization, photogrammetry, camera calibration, head pose estimation, eye gaze estimation, facial landmark detection, identity feature extraction, emotion recognition, active speak recognition, and/or another type of machine learning feature extraction technique. In some examples, the one or more features 802 may be utilized to generate at least a portion of the object detection feature set 602 and/or the people detection feature set 604 for the one or more video frames. Additionally, the metadata 101 may include the one or more features 802, the object detection feature set 602, the people detection feature set 604, and/or one or more other features related to the video data 105 and/or the audio data 106. In some examples, the machine learning architecture 800 may be executed via an edge devices that captures the one or video frames and/or other sensor input related to the video data 105 and/or the audio data 106.

In some examples, one or more features extracted from one or more video frames provided by a first video capture device may be correlated with one or more other features extracted from one or more other video frames provided by a second video capture device. The features may be correlated, for example, based on information provided by a calibration and/or photogrammetry process for the first video capture device and the second video capture device. For example, the first video capture device and the second video capture device may be calibrated and/or configured for the video environment via a photogrammetry process such that camera location information (e.g., x, y and z coordinates), pose information, and/or a projection matrix for the first video capture device and the second video capture device are determined. In some examples, the camera location information, pose information, and/or projection matrix may be utilized for entity localization, feature extraction, and/or one or more other types of modeling by the one or more machine learning models 120.

In some examples, photogrammetry and/or a related photogrammetry feature set may be utilized to estimate a position of a person or object in the video environment. For example, the photogrammetry feature set may refer to collection of data or measurements derived from analyzing multiple images or video frames to reconstruct three-dimensional information regarding objects or scenes in a video environment. The photogrammetry feature set may include: spatial coordinates, camera positions, orientation parameters, depth maps, geometric information, and/or other photogrammetry information extracted from images captured from different viewpoints. In some examples, a set of overlapping images of the video environment may be captured during calibration to generate a projection matrix associated with the video environment. The projection matrix may map 3D coordinates of the video environment to 2D camera coordinates associated with video capture devices in the video environment. In some examples, an inverse of the projection matrix associated with camera position may be utilized to determine a 3D vector associated with a particular space in the video environment and a particular pixel of an image. For example, given a coordinate of a bounding box of a detected person or object, a vector through the 3D space of the video environment may be determined such that the detected person or object is deemed to be located along the vector. In some examples, a depth along the vector may be estimated based on triangulation associated with an intersection of vectors across video capture devices in a 3D space. Additionally or alternatively, a depth along the vector may be estimated based on sensor data, depth associated with a video signal, and/or machine learning model output.

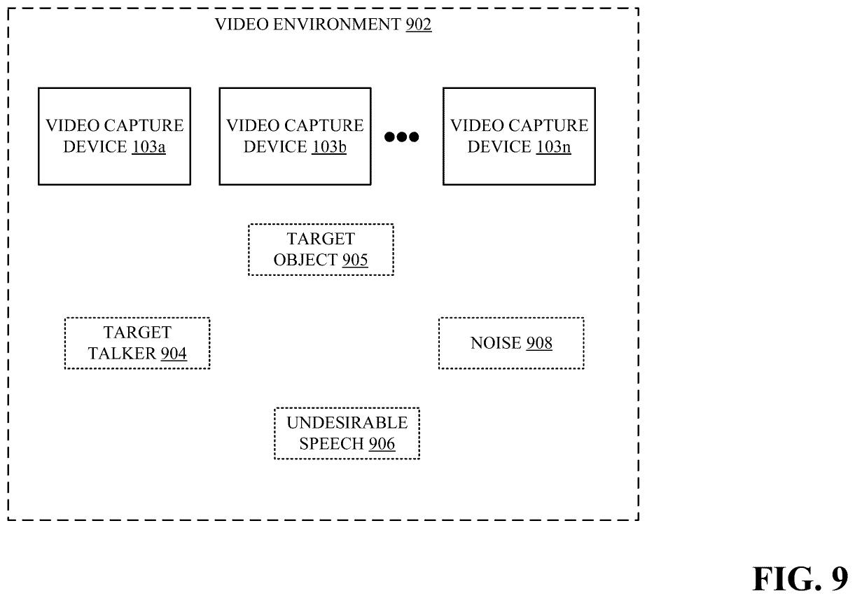

FIG. 9 illustrates an example video environment 902 according to one or more embodiments of the present disclosure. The video environment 902 may be an indoor environment, an outdoor environment, an entertainment environment, a room, a conference room, a meeting room, a classroom, a lecture hall, a performance hall, a broadcasting environment, a sports stadium or arena, a virtual environment, an automobile environment, or another type of video environment. The video environment 902 includes at least the one or more video capture devices 103a-n that are respectively capable of capturing video and/or audio from one or more sources and/or other audio in the video environment 902. For example, the one or more video capture devices 103a-n 102 may capture video and/or audio (e.g., the video data 105 and/or the audio data 106) associated with a target talker 904, a target object 905, undesirable speech 906, and/or noise 908 in the video environment 902. In some examples, the one or more video capture devices 103a-n recognize the target talker 904, modifies a video capture process, and/or steers one or more audio beams based on the control data 113.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

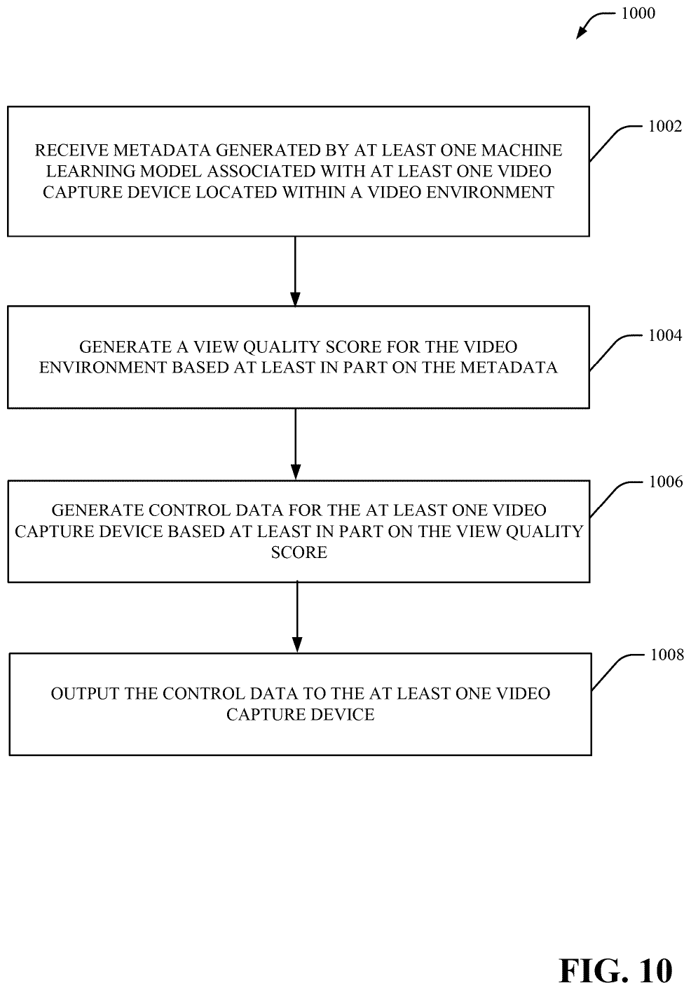

FIG. 10 is a flowchart diagram of an example process 1000 for providing video capture device control based on metadata related to a video environment, in accordance with, for example, the AV processing apparatus 202 illustrated in FIG. 2. Via the various operations of the process 1000, the AV processing apparatus 202 may enhance quality, reliability, and/or source separation of video data for rendering via a display interface.

The process 1000 begins at operation 1002 that receives (e.g., by the video processing circuitry 208 and/or the audio processing circuitry 210) metadata generated by at least one machine learning model associated with at least one video capture device located within a video environment. The video environment may be an indoor environment, an outdoor environment, an entertainment environment, a room, a conference room, a meeting room, a classroom, a lecture hall, a performance hall, a broadcasting environment, a sports stadium or arena, a virtual environment, an automobile environment, or another type of video environment. The metadata may include one or more inferences with respect to the video data and/or the audio data. In some examples, the metadata may include a feature set associated with the video data and/or the audio data. For example, the feature set may include one or more features such as, but not limited to: video features, features associated with video frames, object detection features, object classifications, face recognition features, person recognition features, person classifications, three-dimensional coordinates, facial features, mouth features, head pose features, head pose angles, eye features, eye gaze angles, emotion predictions, active speaking classifications, camera locations, camera poses, depth estimation, color format, frame orientation, frame rotation, natural language processing, video quality, audio features, and/or one or more other features. In some examples, depth estimation metadata may include a depth estimation feature set provided by the at least one machine learning model. In some examples, the depth estimation feature set may include: depth map features, point cloud features, and/or depth estimation features associated with a three-dimensional structure derived from two-dimensional visual input. Additionally or alternatively, depth estimation metadata may include depth estimation data associated with stereo camera data, sensor data (e.g., sensor data associated with a TOF sensor, a LiDAR sensor, and/or another type of sensor), photogrammetry data, and/or other data. In some examples, color format metadata may indicate a type of color format (e.g., RGB, YUV, NV12, etc.) associated with video frames. In some examples, frame orientation metadata may indicate whether video frames are oriented as a landscape orientation or a portrait orientation. In some examples, frame rotation metadata may indicate whether a video frame is rotated horizontally, vertically, diagonally, etc.

The process 1000 also includes an operation 1004 that generates (e.g., by the video processing circuitry 208) a view quality score for the video environment based at least in part on the metadata. For example, the view quality score may be based on respective features included in the metadata. In some examples, the view quality score may be a weighted combination of extracted features associated with the metadata.

The process 1000 also includes an operation 1006 that generates (e.g., by the video processing circuitry 208) control data for the at least one video capture device based at least in part on the view quality score. The control data may be utilized to control and/or configure the at least one video capture device. Control and/or configuration of the at least one video capture device may include: turning particular video processing threads on or off, setting particular parameters for particular video processing threads, initiating particular video related tasks, initiating particular type of encoding task, initiating a video data acquisition task, initiating execution of one a particular machine learning model, enabling speech separation with respect to a video processing thread, modifying one or more video frames associated with a video processing thread, enabling an OCR task associated with one or more video frames associated with a video processing thread, and/or one or more other types of configurations for a video processing thread. In some examples, modifying one or more video frames associated with a video processing thread includes enabling a digital zoom, pan, and/or crop associated with a particular region in one or more video frames associated with a video processing thread. The particular region may include a detected person, a person associated with a digital identifier, a person associated with speech separation, a particular object, a whiteboard region, etc.

The process 1000 also includes an operation 1008 that outputs (e.g., by the input/output circuitry 212) the control data to the at least one video capture device.

In some examples, the metadata is first metadata. In some examples, second metadata generated via digital signal processing associated with a metadata engine that is different than the at least one machine learning model is received. In some examples, the view quality score for the video environment is generated based on the first metadata and the second metadata.

In some examples, a video feature set provided by the at least one machine learning model is received. In some examples, the view quality score for the video environment is generated based on the video feature set.

In some examples, the view quality score for the video environment is modified based on respective weights for respective features included in the video feature set.

In some examples, an object detection feature set provided by the at least one machine learning model is received. In some examples, the view quality score for the video environment is generated based on the object detection feature set.

In some examples, a people detection feature set provided by the at least one machine learning model is received. In some examples, the view quality score for the video environment is generated based on the people detection feature set.

In some examples, a gaze detection feature set provided by the at least one machine learning model is received. In some examples, the view quality score for the video environment is generated based on the gaze detection feature set.

In some examples, the view quality score for the video environment is generated based on a photogrammetry feature set associated with the at least one video capture device.

In some examples, the view quality score for the video environment is generated based on depth estimation metadata.

In some examples, a depth estimation feature set provided by the at least one machine learning model is received. In some examples, the view quality score for the video environment is generated based on the depth estimation feature set.

In some examples, a configuration parameter set for the at least one video capture device is generated based on the view quality score. In some examples, the configuration parameter set is output to the at least one video capture device.

In some examples, device selection data for the at least one video capture device is generated based on the view quality score. In some examples, the device selection data is output to the at least one video capture device.

In some examples, a microphone array beam for an audio capture device in the video environment is steered based on the control data.

In some examples, an object view score for an object in the video environment is generated based on the metadata. In some examples, the control data for the at least one video capture device is generated based on the object view score.

In some examples, a person view score for a person in the video environment is generated based on the metadata. In some examples, the control data for the at least one video capture device is generated based on the person view score.

In some examples, one or more video frames associated with the at least one video capture device are output based on the control data.

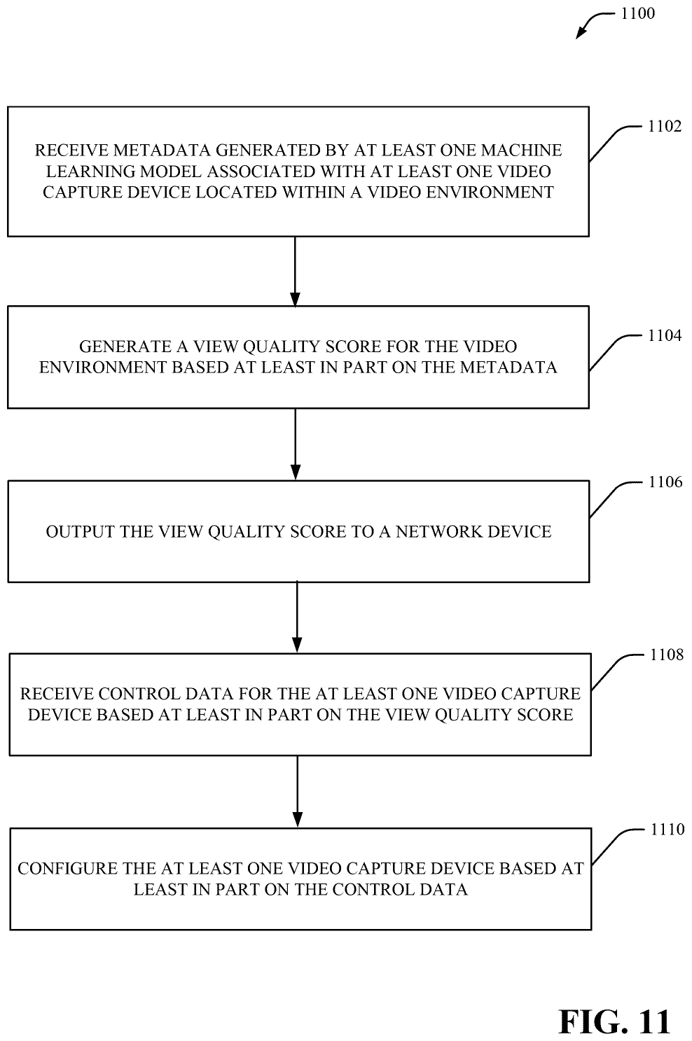

FIG. 11 is a flowchart diagram of an example process 1100 for providing video capture device control based on metadata related to a video environment, in accordance with, for example, the AV processing apparatus 202 illustrated in FIG. 2. Via the various operations of the process 1100, the AV processing apparatus 202 may enhance quality, reliability, and/or source separation of video data for rendering via a display interface.

The process 1100 begins at operation 1102 that receives (e.g., by the video processing circuitry 208 and/or the audio processing circuitry 210) metadata generated by at least one machine learning model associated with at least one video capture device located within a video environment. The video environment may be an indoor environment, an outdoor environment, an entertainment environment, a room, a conference room, a meeting room, a classroom, a lecture hall, a performance hall, a broadcasting environment, a sports stadium or arena, a virtual environment, an automobile environment, or another type of video environment. The metadata may include one or more inferences with respect to the video data and/or the audio data. In some examples, the metadata may include a feature set associated with the video data and/or the audio data. For example, the feature set may include one or more features such as, but not limited to: video features, features associated with video frames, object detection features, object classifications, face recognition features, person recognition features, person classifications, three-dimensional coordinates, facial features, mouth features, head pose features, head pose angles, eye features, eye gaze angles, emotion predictions, active speaking classifications, camera locations, camera poses, depth estimation, color format, frame orientation, frame rotation, natural language processing, video quality, audio features, and/or one or more other features. In some examples, depth estimation metadata may include a depth estimation feature set provided by the at least one machine learning model. Additionally or alternatively, depth estimation metadata may include depth estimation data associated with stereo camera data, sensor data (e.g., sensor data associated with a TOF sensor, a LiDAR sensor, and/or another type of sensor), photogrammetry data, and/or other data. In some examples, color format metadata may indicate a type of color format (e.g., RGB, YUV, NV12, etc.) associated with video frames. In some examples, frame orientation metadata may indicate whether video frames are oriented as a landscape orientation or a portrait orientation. In some examples, frame rotation metadata may indicate whether a video frame is rotated horizontally, vertically, diagonally, etc.

The process 1100 also includes an operation 1104 that generates (e.g., by the video processing circuitry 208) a view quality score for the video environment based at least in part on the metadata. For example, the view quality score may be based on respective features included in the metadata. In some examples, the view quality score may be a weighted combination of extracted features associated with the metadata.

The process 1100 also includes an operation 1106 that outputs (e.g., by the input/output circuitry 212) the view quality score to a network device.

The process 1100 also includes an operation 1108 that receives (e.g., by the input/output circuitry 212) control data for the at least one video capture device based at least in part on the view quality score.

The process 1100 begins at operation 1110 that configures (e.g., by the video processing circuitry 208 and/or the audio processing circuitry 210) the at least one video capture device based at least in part on the control data. Control and/or configuration of the at least one video capture device may include: turning particular video processing threads on or off, setting particular parameters for particular video processing threads, initiating particular video related tasks, initiating particular type of encoding task, initiating a video data acquisition task, initiating execution of one a particular machine learning model, enabling speech separation with respect to a video processing thread, modifying one or more video frames associated with a video processing thread, enabling an OCR task associated with one or more video frames associated with a video processing thread, and/or one or more other types of configurations for a video processing thread. In some examples, modifying one or more video frames associated with a video processing thread includes enabling a digital zoom, pan, and/or crop associated with a particular region in one or more video frames associated with a video processing thread. The particular region may include a detected person, a person associated with a digital identifier, a person associated with speech separation, a particular object, a whiteboard region, etc.

In some examples, one or more video frames associated with the at least one video capture device may be output based on the control data.

In some examples, video data associated with the at least one video capture device may be encoded based on the control data. In some examples, the encoded video data may be output to the network device.

In some examples, one or more video frames associated with the at least one video capture device may be output based on a determination that one or more features included in the metadata satisfies threshold value criteria.

Although example processing systems have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, i.e., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

A computer program (also known as a program, software, software application, script, or code) may be written in any form of programming language, including compiled or interpreted languages, declarative or procedural languages, and it may be deployed in any form, including as a stand-alone program or as a module, engine, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms, such as consisting of, consisting essentially of, comprised substantially of, and/or the like.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment.

Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. An apparatus comprising at least one processor and a memory storing instructions that are operable, when executed by the processor, to cause the apparatus to: receive metadata generated by at least one machine learning model associated with at least one video capture device located within a video environment.

Clause 2. The apparatus of clause 1, wherein the instructions are further operable to cause the apparatus to: generate a view quality score for the video environment based at least in part on the metadata.

Clause 3. The apparatus of any one of the foregoing clauses, wherein the instructions are further operable to cause the apparatus to: generate control data for the at least one video capture device based at least in part on the view quality score.

Clause 4. The apparatus of any one of the foregoing clauses, wherein the instructions are further operable to cause the apparatus to: output the control data to the at least one video capture device.

Clause 5. The apparatus of any one of the foregoing clauses, wherein the metadata is first metadata and the instructions are further operable to cause the apparatus to: receive second metadata generated via digital signal processing associated with a metadata engine that is different than the at least one machine learning model.

Clause 6. The apparatus of any one of the foregoing clauses, wherein the instructions are further operable to cause the apparatus to: generate the view quality score for the video environment based at least in part on the first metadata and the second metadata.

Clause 7. The apparatus of any one of the foregoing clauses, wherein the instructions are further operable to cause the apparatus to: receive a video feature set provided by the at least one machine learning model.

Clause 8. The apparatus of any one of the foregoing clauses, wherein the instructions are further operable to cause the apparatus to: generate the view quality score for the video environment based at least in part on the video feature set.

Clause 9. The apparatus of any one of the foregoing clauses, wherein the instructions are further operable to cause the apparatus to: modify the view quality score for the video environment based at least in part on respective weights for respective features included in the video feature set.

Clause 10. The apparatus of any one of the foregoing clauses, wherein the instructions are further operable to cause the apparatus to: receive an object detection feature set provided by the at least one machine learning model.

Clause 11. The apparatus of any one of the foregoing clauses, wherein the instructions are further operable to cause the apparatus to: generate the view quality score for the video environment based at least in part on the object detection feature set.

Clause 12. The apparatus of any one of the foregoing clauses, wherein the instructions are further operable to cause the apparatus to: receive a people detection feature set provided by the at least one machine learning model.

Clause 13. The apparatus of any one of the foregoing clauses, wherein the instructions are further operable to cause the apparatus to: generate the view quality score for the video environment based at least in part on the people detection feature set.

Clause 14. The apparatus of any one of the foregoing clauses, wherein the instructions are further operable to cause the apparatus to: receive a gaze detection feature set provided by the at least one machine learning model.

Clause 15. The apparatus of any one of the foregoing clauses, wherein the instructions are further operable to cause the apparatus to: generate the view quality score for the video environment based at least in part on the gaze detection feature set.

Clause 16. The apparatus of any one of the foregoing clauses, wherein the instructions are further operable to cause the apparatus to: generate the view quality score for the video environment based at least in part on a photogrammetry feature set associated with the at least one video capture device.

Clause 17. The apparatus of any one of the foregoing clauses, wherein the instructions are further operable to cause the apparatus to: generate the view quality score for the video environment based at least in part on depth estimation metadata.

Clause 18. The apparatus of any one of the foregoing clauses, wherein the instructions are further operable to cause the apparatus to: receive a depth estimation feature set provided by the at least one machine learning model.

Clause 19. The apparatus of any one of the foregoing clauses, wherein the instructions are further operable to cause the apparatus to: generate the view quality score for the video environment based at least in part on the depth estimation feature set.

Clause 20. The apparatus of any one of the foregoing clauses, wherein the instructions are further operable to cause the apparatus to: generate a configuration parameter set for the at least one video capture device based at least in part on the view quality score.

Clause 21. The apparatus of any one of the foregoing clauses, wherein the instructions are further operable to cause the apparatus to: output the configuration parameter set to the at least one video capture device.

Clause 22. The apparatus of any one of the foregoing clauses, wherein the instructions are further operable to cause the apparatus to: generate device selection data for the at least one video capture device based at least in part on the view quality score.

Clause 23. The apparatus of any one of the foregoing clauses, wherein the instructions are further operable to cause the apparatus to: output the device selection data to the at least one video capture device.

Clause 24. The apparatus of any one of the foregoing clauses, wherein the instructions are further operable to cause the apparatus to: steer a microphone array beam for an audio capture device in the video environment based at least in part on the control data.

Clause 25. The apparatus of any one of the foregoing clauses, wherein the instructions are further operable to cause the apparatus to: generate an object view score for an object in the video environment based at least in part on the metadata.

Clause 26. The apparatus of any one of the foregoing clauses, wherein the instructions are further operable to cause the apparatus to: generate the control data for the at least one video capture device based at least in part on the object view score.

Clause 27. The apparatus of any one of the foregoing clauses, wherein the instructions are further operable to cause the apparatus to: generate person view score for a person in the video environment based at least in part on the metadata.

Clause 28. The apparatus of any one of the foregoing clauses, wherein the instructions are further operable to cause the apparatus to: generate the control data for the at least one video capture device based at least in part on the person view score.

Clause 29. The apparatus of any one of the foregoing clauses, wherein the instructions are further operable to cause the apparatus to: output one or more video frames related to the at least one video capture device based at least in part on the control data.

Clause 30. A computer-implemented method comprising steps in accordance with any one of the foregoing clauses.

Clause 31. A computer program product, stored on a computer readable medium, comprising instructions that, when executed by one or more processors of the audio signal processing apparatus, cause the one or more processors to perform one or more operations related to any one of the foregoing clauses.

Clause 32. An apparatus comprising at least one processor and a memory storing instructions that are operable, when executed by the processor, to cause the apparatus to: generate metadata generated by at least one machine learning model associated with at least one video capture device located within a video environment.

Clause 33. The apparatus of clause 32, wherein the instructions are further operable to cause the apparatus to: generate a view quality score for the video environment based at least in part on the metadata.

Clause 34. The apparatus of any one of the foregoing clauses, wherein the instructions are further operable to cause the apparatus to: output the view quality score to a network device.

Clause 35. The apparatus of any one of the foregoing clauses, wherein the instructions are further operable to cause the apparatus to: receive control data for the at least one video capture device based at least in part on the view quality score.

Clause 36. The apparatus of any one of the foregoing clauses, wherein the instructions are further operable to cause the apparatus to: configure the at least one video capture device based at least in part on the control data.

Clause 37. The apparatus of any one of the foregoing clauses, wherein the instructions are further operable to cause the apparatus to: output one or more video frames associated with the at least one video capture device based at least in part on the control data.

Clause 38. The apparatus of any one of the foregoing clauses, wherein the instructions are further operable to cause the apparatus to: encode video data associated with the at least one video capture device based at least in part on the control data.

Clause 39. The apparatus of any one of the foregoing clauses, wherein the instructions are further operable to cause the apparatus to: output the encoded video data to the network device.

Clause 40. The apparatus of any one of the foregoing clauses, wherein the instructions are further operable to cause the apparatus to: output one or more video frames associated with the at least one video capture device based on a determination that one or more features included in the metadata satisfies threshold value criteria.

Clause 41. A computer-implemented method comprising steps in accordance with any one of the foregoing clauses.

Clause 42. A computer program product, stored on a computer readable medium, comprising instructions that, when executed by one or more processors of the audio signal processing apparatus, cause the one or more processors to perform one or more operations related to any one of the foregoing clauses.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. An apparatus comprising at least one processor and a memory storing instructions that are operable, when executed by the processor, to cause the apparatus to:
receive metadata generated by at least one machine learning model associated with at least one video capture device located within a video environment;
generate a view quality score for the video environment based at least in part on the metadata;
generate control data for the at least one video capture device based at least in part on the view quality score; and
output the control data to the at least one video capture device.

2. The apparatus of claim 1, wherein the metadata is first metadata, and wherein the instructions are further operable to cause the apparatus to:
receive second metadata generated via digital signal processing associated with a metadata engine that is different than the at least one machine learning model; and
generate the view quality score for the video environment based at least in part on the first metadata and the second metadata.

3. The apparatus of claim 1, wherein the instructions are further operable to cause the apparatus to:
receive a video feature set provided by the at least one machine learning model; and
generate the view quality score for the video environment based at least in part on the video feature set.

4. The apparatus of claim 3, wherein the instructions are further operable to cause the apparatus to:
modify the view quality score for the video environment based at least in part on respective weights for respective features included in the video feature set.

5. The apparatus of claim 1, wherein the instructions are further operable to cause the apparatus to:
receive an object detection feature set provided by the at least one machine learning model; and
generate the view quality score for the video environment based at least in part on the object detection feature set.

6. The apparatus of claim 1, wherein the instructions are further operable to cause the apparatus to:
receive a people detection feature set provided by the at least one machine learning model; and
generate the view quality score for the video environment based at least in part on the people detection feature set.

7. The apparatus of claim 1, wherein the instructions are further operable to cause the apparatus to:
receive a gaze detection feature set provided by the at least one machine learning model; and
generate the view quality score for the video environment based at least in part on the gaze detection feature set.

8. The apparatus of claim 1, wherein the instructions are further operable to cause the apparatus to:
generate the view quality score for the video environment based at least in part on a photogrammetry feature set associated with the at least one video capture device.

9. The apparatus of claim 1, wherein the instructions are further operable to cause the apparatus to:
generate the view quality score for the video environment based at least in part on depth estimation metadata.

10. The apparatus of claim 1, wherein the instructions are further operable to cause the apparatus to:
receive a depth estimation feature set provided by the at least one machine learning model; and
generate the view quality score for the video environment based at least in part on the depth estimation feature set.

11. The apparatus of claim 1, wherein the instructions are further operable to cause the apparatus to:
generate a configuration parameter set for the at least one video capture device based at least in part on the view quality score; and
output the configuration parameter set to the at least one video capture device.

12. The apparatus of claim 1, wherein the instructions are further operable to cause the apparatus to:
generate device selection data for the at least one video capture device based at least in part on the view quality score; and
output the device selection data to the at least one video capture device.

13. The apparatus of claim 1, wherein the instructions are further operable to cause the apparatus to:
steer a microphone array beam for an audio capture device in the video environment based at least in part on the control data.

14. The apparatus of claim 1, wherein the instructions are further operable to cause the apparatus to:
generate an object view score for an object in the video environment based at least in part on the metadata; and
generate the control data for the at least one video capture device based at least in part on the object view score.

15. The apparatus of claim 1, wherein the instructions are further operable to cause the apparatus to:
generate person view score for a person in the video environment based at least in part on the metadata; and
generate the control data for the at least one video capture device based at least in part on the person view score.

16. The apparatus of claim 1, wherein the instructions are further operable to cause the apparatus to:
output one or more video frames associated with the at least one video capture device based at least in part on the control data.

17. A computer-implemented method comprising:
receiving metadata generated by at least one machine learning model associated with at least one video capture device located within a video environment;
generating a view quality score for the video environment based at least in part on the metadata;
generating control data for the at least one video capture device based at least in part on the view quality score; and
outputting the control data to the at least one video capture device.

18. The computer-implemented method of claim 17, wherein the metadata is first metadata, and the computer-implemented method further comprising:
receiving second metadata generated via digital signal processing associated with a metadata engine that is different than the at least one machine learning model; and
generating the view quality score for the video environment based at least in part on the first metadata and the second metadata.

19. The computer-implemented method of claim 17, further comprising:
receiving a video feature set provided by the at least one machine learning model; and
generating the view quality score for the video environment based at least in part on the video feature set.

20. A computer program product, stored on a computer readable medium, comprising instructions that, when executed by one or more processors of an apparatus, cause the one or more processors to:
receive metadata generated by at least one machine learning model associated with at least one video capture device located within a video environment;
generate a view quality score for the video environment based at least in part on the metadata;
generate control data for the at least one video capture device based at least in part on the view quality score; and
output the control data to the at least one video capture device.
